(19) United States
(12) Patent Application Publication
(10) Pub. No.: US 2024/0225000 A1
(43) Pub. Date: Jul. 11, 2024

(54) Insecticidal Composition Comprising of Diamide Compounds

(71) Applicant: WILLOWOOD CHEMICALS PRIVATE LIMITED, New Delhi (IN)

(72) Inventors: Parikshit MUNDHRA, New Delhi (IN); Jitendra MOHAN, New Delhi (IN)

(21) Appl. No.: 18/278,542

(22) PCT Filed: Feb. 21, 2022
(86) PCT No.: PCT/IN2022/050153

§ 371 Date: Aug. 23, 2023

(30) Foreign Application Priority Data
Feb. 25, 2021 (IN) 202111008066
May 10, 2021 (IN) 202111021163

(51) Int. Cl. A01N 43/56; A01N 25/10; A01N 41/10; A01N 43/40; A01N 47/30; A01N 53/00; A01P 7/04

(52) U.S. Cl. CPC A01N 43/56; A01N 25/10; A01N 41/10; A01N 43/40; A01N 47/30; A01N 53/00; A01P 7/04

(57) ABSTRACT

The present provides a synergistic insecticidal composition comprising Chlorantraniliprole. Flubendiamide and at least one insecticidal compound selected from Pyriproxyfen. Diafenthiuron, Bifenthrin or Lambda-Cyhalothrin., process of preparation of the composition and uses thereof.

This application claims priority from IN 202111008066 (date of filing 25 February, 2021) and IN 202111021163 (date of filing 10 May 2021).

### FIELD OF THE INVENTION

The present invention relates to a synergistic insecticidal composition comprising Chlorantraniliprole, Flubendiamide and at least one insecticidal compound selected from Pyriproxyfen, Diafenthiuron, Bifenthrin or Lambda-Cyhalothrin. The present invention also provides the process of preparation of the composition and uses thereof.

### BACKGROUND OF THE INVENTION

In economically important crops, higher crop efficiency is achieved by controlling the invertebrate pests. Invertebrate pest causes damage to growing and stored agronomic crops and thereby result in significant reduction in the crop productivity. Therefore, the control of invertebrate pests is economically important for the enhanced crop productivity. Many products are available as solo or in combinations of two or more active ingredients. However, more economically efficient and ecologically safe pesticidal composition and methods are still being sought.

In order to reduce the risk from increased number of resistant pest strains, mixtures of different active compounds are nowadays employed for controlling harmful pests. By combining different active compounds having different mechanisms of action, it is possible to attain effective control of pests of different groups over a relatively longer period of time and preventing development of resistance.

Therefore, there exist a need in the art to develop an insecticidal composition, which is stable, synergistic, broad spectrum, environmentally safe, and more effective in control of a wide spectrum of insect pests in crops. The insecticidal compositions must show a broader scope of activity to avoid or to prevent the development of resistant varieties of strains to the active ingredients or to the mixtures of known active ingredients used by farmer while minimising the doses of chemicals sprayed in the agriculture fields.

As a solution to the above mentioned problems, the inventors of the present invention surprisingly found that composition comprising Chlorantraniliprole, Flubendiamide and at least one insecticidal compound selected from Pyriproxyfen, Diafenthiuron, Bifenthrin, or Lambda-Cyhalothrin provides effective control of a wide spectrum of insect pests.

### SUMMARY OF THE INVENTION

Accordingly, the present invention provides a synergistic insecticidal composition comprising: Chlorantraniliprole, Flubendiamide, at least one compound selected from Pyriproxyfen, Diafenthiuron, Bifenthrin or Lambda-Cyhalothrin, and one or more excipients.

In an embodiment, Chlorantraniliprole is present in an amount in the range of 1 to 20% w/w, Flubendiamide is present in an amount in the range of 1 to 20% w/w; and at least one compound selected from Pyriproxyfen, Diafenthiuron, Bifenthrin or Lambda-Cyhalothrin present in an amount of 0.1 to 50% w/w. In another embodiment, Pyriproxyfen is present in an amount in the range from 5 to 50% w/w, Diafenthiuron is present in an amount in the range from 0.1 to 40% w/w, Bifenthrin is present in an amount in the range from 5 to 30% w/w or Lambda-Cyhalothrin is present in an amount in the range from 0.1 to 40% w/w.

In a preferred embodiment, the composition of the present invention is selected from a group comprising:
a. 10% w/w of Chlorantraniliprole, 10% w/w of Flubendiamide; 20% w/w of Pyriproxyfen and one or more excipients;
b. 3% w/w of Chlorantraniliprole, 5% w/w of Flubendiamide; 30% w/w of Diafenthiuron and one or more excipients;
c. 6% w/w of Chlorantraniliprole, 10% w/w of Flubendiamide; 16% w/w of Bifenthrin and one or more excipients;
d. 12% w/w of Chlorantraniliprole, 20% w/w of Flubendiamide; 6% w/w of Lambda-Cyhalothrin and one or more excipients; and
e. 6% w/w of Chlorantraniliprole, 10% w/w of Flubendiamide; 3% w/w of Lambda-Cyhalothrin and one or more excipients.

In one another embodiment, the composition is formulated as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO),

Emulsifiable powder (EP), Emulsion for seed treatment (ES), Emulsion oil-in-water (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG), Wettable powder (WP), Water dispersible powder for slurry seed treatment (WS), Water dispersible tablet (WT), a mixed formulation of CS and SC (ZC) or a mixed formulation of CS and SE (ZE), a mixed formulation of CS and EW (ZW). In a preferred embodiment, the composition is formulated as SC, SE and ZC.

In yet another embodiment, the excipient is selected from the group comprising of dispersing agent present in an amount in the range from 2 to 10% w/w, wetting agent present in an amount in the range from 1 to 5% w/w, emulsifier present in an amount in the range from 2 to 7% w/w, anti-freeze agent present in an amount in the range from 1 to 10% w/w, defoamer present in an amount in the range from 0.01 to 0.5% w/w, biocide present in an amount in the range from 0.01 to 0.5% w/w, thickener present in an amount in the range from 0.01 to 0.5% w/w, solvent present in an amount in the range from 5 to 15% w/w, and capsule forming monomer I and II present in an amount in the range from 0.2 to 3% w/w.

In an embodiment, the dispersing agent is selected from the group comprising of amine salt of phosphate tristyryl phenol ethoxylated, acrylic copolymer, graft copolymer, salt of naphthalene sulphonate, naphthalene sulfonate formaldehyde condensate, phosphate ester, salt of polycarboxylate, alcohol block copolymer, ethoxylated polyarylphenol phosphate ester, tristyrylphenol ethoxylate phosphate ester, or a combination thereof. The wetting agent is selected from the group comprising of ethoxylated polyarylphenol phosphate ester, dioctyl sulphosuccinate, non-ionic ethoxylate, castor oil ethoxylate or a combination thereof. The emulsifier is selected from the group comprising of polyethylene oxide block copolymer, high molecular weight polymer (polyvinyl alcohol), PEG-10 PPG-5 cetyl phosphate, ethylene oxide (EO)—polyethylene oxide (PO) block copolymer, tristyryl phenol, ethoxylated nonionic emulsifier, blend of non-ionic—anionic emulsifiers or a combination thereof. The anti-freeze agent is selected from the group comprising of propylene glycol, diethylene glycol, monoethylene glycol or a combination thereof. The defoamer is selected from the group comprising of silicon emulsion, dimethyl polysiloxane emulsion, polysiloxane emulsion or a combination thereof. The biocide is selected from the group comprising of 20% aqueous dipropylene glycol solution of 1,2-benzisothiazolin-3-one, formaldehyde, isothiazolinone or a combination thereof. The thickener is xanthan gum. The solvent is selected from the group comprising of naphtha, butan-1-ol, xylene, decanamide, N-methyl-2-pyrrolidone, dimethyl sulfoxide, solvent C9, water or a combination thereof.

In another embodiment, the capsule forming monomer I is selected from polyisocyanate, toluene di-isocyanate and tri-isocyanate present in an amount in the range from 0.5 to 3% w/w and the capsule forming monomer II is selected from ethylenediamine, diethylenetetramine and hexaethylenediamine present in an amount in the range from 0.2 to 2% w/w.

### DETAILED DESCRIPTION OF THE INVENTION

The definitions provided herein below for the terminologies used in the present disclosure are for illustrative purpose only and in no manner limit, the scope of the present invention disclosed in the present disclosure.

Unless defined otherwise, all technical and scientific terms used herein have the same meaning as commonly understood by one of ordinary skill in the art to which the invention pertains. Although other methods and materials similar, or equivalent, to those described herein can be used in the practice of the present invention, the preferred materials and methods are described herein.

As used herein, the term “composition” or “formulation” can be used interchangeably. The expression of various quantities in terms of “% w/w” or “%” means the percentage by weight, relative to the weight of the total solution or composition unless otherwise specified.

The term “active ingredient”, “(a.i.)” or “active agent” used herein refers to that component of the composition responsible for control of insect pests.

As used herein, the term “Chlorantraniliprole” encompasses its agrochemically acceptable salt(s), derivative(s) or any other modified form of Chlorantraniliprole. It belongs to the class of diamide insecticide. It acts by activation of ryanodine receptors, leading to loss of internal calcium stores.

As used herein, the term “Flubendiamide” encompasses its agrochemically acceptable salt(s), derivative(s) or any other modified form of Flubendiamide. It belongs to the class of diamide insecticide. It acts by activation of the ryanodine receptor, a calcium release channel which is involved in muscle contraction.

As used herein, the term “Pyriproxyfen” encompasses its agrochemically acceptable salt(s), derivative(s) or any other modified form of Pyriproxyfen. It belongs to the class of juvenile hormone mimic. It acts as an insect juvenile hormone analogue that inhibits insect maturation processes.

As used herein, the term “Diafenthiuron” encompasses its agrochemically acceptable salt(s), derivative(s) or any other modified form of Diafenthiuron. Diafenthiuron belongs to the class of thiourea insecticide. It acts by contact and/or stomach action; also shows some ovicidal action.

As used herein, the term “Bifenthrin” encompasses its agrochemically acceptable salt(s), derivative(s) or any other modified form of Bifenthrin. It belongs to the class of pyrethroid insecticide. It acts on the nervous system of insects, disturbs the function of neurons by interaction with the sodium channel.

As used herein, the term “Lambda-Cyhalothrin” encompasses its agrochemically acceptable salt(s), derivative(s) or any other modified form of Lambda-cyhalothrin. It belongs to the class of pyrethroid insecticide. It acts on the nervous system of insects and disturbs the function of neurons by interaction with the sodium channels.

The present invention provides a synergistic compositions comprising of Chlorantraniliprole, Flubendiamide and at least one insecticidal compound selected from Pyriproxyfen, Diafenthiuron, Bifenthrin or Lambda-Cyhalothrin.

It has been surprisingly found that composition comprising of Chlorantraniliprole, Flubendiamide and at least one insecticidal compound selected from Pyriproxyfen, Diafenthiuron, Bifenthrin or Lambda-Cyhalothrin not only provides effective control of insect pests but also such combination is synergistic in nature.

The composition according to the present invention comprises of Chlorantraniliprole in an amount in the range from 1 to 20% w/w; Flubendiamide in an amount in the range from 1 to 20% w/w; and the at least one compound selected from Pyriproxyfen, Diafenthiuron, Bifenthrin or Lambda-Cyhalothrin in an amount in the range from 0.1 to 50%. Particularly, Pyriproxyfen is present in the range from 5 to 50% w/w, Diafenthiuron is present in the range from 0.1 to 40% w/w, Bifenthrin is present in the range from 5 to 30% w/w and Lambda-Cyhalothrin is present in the range from 0.1 to 40% w/w.

In an embodiment, the composition is selected from a group comprising:
10% w/w of Chlorantraniliprole, 10% w/w of Flubendiamide; 20% w/w of Pyriproxyfen and one or more excipients;
3% w/w of Chlorantraniliprole, 5% w/w of Flubendiamide; 30% w/w of Diafenthiuron and one or more excipients;
6% w/w of Chlorantraniliprole, 10% w/w of Flubendiamide; 16% w/w of Bifenthrin and one or more excipients;
12% w/w of Chlorantraniliprole, 20% w/w of Flubendiamide; 6% w/w of Lambda-Cyhalothrin and one or more excipients; and
6% w/w of Chlorantraniliprole, 10% w/w of Flubendiamide; 3% w/w of Lambda-Cyhalothrin and one or more excipients.

In another embodiment, the composition is formulated as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG), Wettable powder (WP), Water dispersible powder for slurry seed treatment (WS), Water dispersible tablet (WT), a mixed formulation of CS and SC (ZC) or a mixed formulation of CS and SE (ZE), a mixed formulation of CS and EW (ZW). The composition of the present invention is preferably formulated as SC, SE and ZC.

In an aspect, the composition of the present invention comprises of excipients selected from the group comprising of dispersing agent, wetting agent, emulsifier, anti-freeze agent, defoamer, biocide, thickener, solvent and capsule forming monomer I and II or a combination thereof and other excipients as will be required in a particular type of formulation. In another aspect, the composition is formulated as SC and comprises of one or more excipient selected from dispersing agent, wetting agent, anti-freeze agent, defoamer, biocide, thickener and demineralized water. In one another aspect, the composition is formulated as SE and comprises of one or more excipient selected from dispersing agent, wetting agent, emulsifier, anti-freeze agent, defoamer, biocide, solvent, thickener and demineralized water. In yet another aspect, the composition is formulated as ZC and one or more excipient selected from dispersing agent, wetting agent, emulsifier, anti-freeze agent, defoamer, biocide, thickener, solvent, capsule forming monomer I and II, and demineralized water.

It is generally observed that solid particles in a liquid undergo spontaneous aggregation to form lumps. Hence, it is recommended to add a dispersing agent which prevents agglomeration of solid particles and keep them suspended in fluid. Accordingly, the composition of the present invention contains dispersing agent such as amine salt of phosphate tristyryl phenol ethoxylated, acrylic copolymer, graft copolymer, salt of naphthalene sulphonate, naphthalene sulfonate formaldehyde condensate, phosphate ester, salt of polycarboxylate, alcohol block copolymer, ethoxylated polyarylphenol phosphate ester, tristyrylphenol ethoxylate phosphate ester. One or more dispersing agents may be used in the composition of the present invention. The dispersing agent is present in an amount in the range from 2 to 10% w/w.

Wetting is the first stage of dispersion, in which air surrounding the granular composition is substituted with water. Wetting of the composition with water cannot occur if the surface tension of the liquid is very high. Hence, it is recommended to add a wetting agent to the composition to facilitate the process of dispersion of the granules in the liquid. Non-limiting examples of wetting agents that can be used in the composition include ethoxylated polyarylphenol phosphate ester, dioctyl sulphosuccinate, non-ionic ethoxylate, castor oil ethoxylate. One or more wetting agents may be used in the composition of the present invention. The wetting agent is present in an amount in the range from 1 to 5% w/w.

An emulsifier is a kind of surfactant. It helps to prevent the droplets of the dispersed phase of an emulsion from flocculating or coalescing in the emulsion. It can be or include a cationic, zwitterionic or a non-ionic emulsifier. Suitable emulsifier used herein, but not limited to, polyethylene oxide block copolymer, high molecular weight polymer (polyvinyl alcohol), PEG-10 PPG-5 cetyl phosphate, ethylene oxide (EO)—polyethylene oxide (PO) block copolymer, tristyryl phenol, ethoxylated nonionic emulsifier, blend of non-ionic—anionic emulsifiers (proprietary blend) or a combination thereof. Preferably, emulsifier is present in an amount in the range from 2 to 7% w/w.

An anti-freeze agent is generally added to the composition, to prevent the aqueous compositions from freezing. Suitable anti-freeze agents used herein, but not limited to, glycerine, propylene glycol, diethylene glycol, monoethylene glycol or a combination thereof and present in an amount in the range from 1 to 10% w/w.

A defoamer is generally added to the composition, as foam formation prevents the efficient filling of a container. Suitable defoamer used herein, but not limited to, silicon emulsion, dimethyl polysiloxane emulsion, polysiloxane emulsion or a combination thereof and present in an amount in the range from 0.01 to 0.5% w/w.

A biocide is added to the composition of the present invention for its preservation against spoilage from bacteria, yeasts and fungi. Suitable biocide used herein, but not limited to, 20% aqueous dipropylene glycol solution of 1,2-benzisothiazolin-3-one, formaldehyde, isothiazolinone or a combination thereof, and present in an amount in the range from 0.01 to 0.50% w/w.

A thickener is added to the composition to reduce the tendency of the composition to disperse when sprayed, and decrease the likelihood of it being rinsed off from the crops. Suitable thickener used herein are water-soluble polymer and inorganic fine powder. The water-soluble polymer is selected from xanthan gum, welan gum, guar gum, polyvinyl alcohol, carboxymethylcellulose, polyvinylpyrrolidone, carboxyvinyl polymer, acrylic polymer, starch derivative or polysaccharide. The inorganic fine powder is selected from high purity silica, bentonite, white carbon or a combination thereof. The thickener is present in an amount in the range from 0.01 to 0.5% w/w. Xanthan gum used in the present invention is obtained from a commercial source.

The solvent used in the present invention is selected from the group comprising of water; alcohols such as ethanol, propanol, butan-1-ol, n-octanol, isopropanol ethylene glycol, diethylene glycol, propylene glycol, polyethylene glycol, glycerine; polyol ethers such as ethylene glycol monopropyl ether, diethylene glycol monomethyl ether, dipropylene glycol dimethyl ether; ketones such as acetone, methyl ethyl ketone, methyl isobutyl ketone, cyclohexanone; ethers such as dipropyl ether, dioxane, tetrahydrofuran; aliphatic hydrocarbons such as normal paraffin, isoparaffin, kerosene, mineral oil; aromatic hydrocarbons such as xylene, toluene, naphthalene, solvent naphtha, solvent C9, solvent C10, solvent C12, solvesso 100, solvesso 150, solvesso 200; chlorinated aliphatic or aromatic hydrocarbons such as chlorobenzene, chloroethylene, methylene chloride; esters such as ethyl acetate, diisopropyl phthalate, dimethyl adipate, methyl oleate, methyl tallowate; lactones such as gamma-butyrolactone; amides such as dimethylformamide, N-methyl-2-pyrrolidone, N-octylpyrolidone, decanamide, N,N-dimethyldecanamide; nitriles such as acetonitrile; organosulfur compound such as dimethyl sulfoxide. The solvent may be used alone or in combination and is present in an amount 5 to 15% w/w.

The composition of the present invention also comprises of capsule forming monomer I and II. The capsule forming monomer I is selected from polyisocyanate, toluene di-isocyante and tri-isocyanate present in an amount in the range from 0.5 to 3% w/w; and the capsule forming monomer II is selected from ethylenediamine, diethylenetetramine and hexaethylenediamine present in an amount in the range from 0.2 to 2% w/w.

The composition of the present invention can be applied by any one of the methods selected from atomization, spreading, dusting, spraying, diffusion, immersion, irrigation, injection, mixing, sprinkling (water immersion), foaming, dressing, coating, blasting, fumigation, smoking, smog and painting.

In an embodiment, the present invention provides a process for the preparation of the composition in SC form. The process comprises mixing water, biocide, defoamer, anti-freeze agent, dispersing agent and wetting agent. To the same, Chlorantraniliprole, Flubendiamide and at least one compound selected from Pyriproxyfen, Diafenthiuron, Bifenthrin or Lambda-Cyhalothrin are added and mixed to obtain a homogeneous slurry. The slurry is then wet grinded in a suitable mill till required particle size is obtained. To the grinded mass, water solution of thickener is added with low shear mixing to obtain the composition in SC form.

In another embodiment, the present invention provides a process for the preparation of a SE formulation. The process comprises: a) mixing of Chlorantraniliprole, Flubendiamide and at least one excipient to prepare a first composition in the form of SC, b) mixing at least one compound selected from Pyriproxyfen, Diafenthiuron, Bifenthrin or Lambda-Cyhalothrin with a solvent, an emulsifier to obtain a second composition in the form of EW/EC, c) mixing of first composition, second composition and thickener results in a composition of the present invention in SE form.

In yet another embodiment, the present invention provides a process for the preparation of a ZC composition. The process comprises: a) mixing Chlorantraniliprole, Flubendiamide, and at least one excipient to prepare a first composition in the form of SC b) mixing at least one compound selected from Pyriproxyfen, Diafenthiuron, Bifenthrin or Lambda-Cyhalothrin, solvent and capsule forming monomer I to obtain an organic phase c) mixing water and at least one excipient to obtain an aqueous phase d) mixing both the phases and capsule forming monomer II to obtain second composition in the form of CS e) final mixing of first composition and second composition to obtain ZC formulation.

The synergistic composition of the present invention is found to be effective to control wide spectrum of insect pests from the orders of Lepidoptera, Coleoptera, Diptera, Isoptera, Heteropetera, Homoptera, Acarina, Thysanoptera, and Orthoptera. The composition may be used to control of variety of insect pests in cereals, paddy, pulses, oilseeds, horticulture crops, pasture crops, fibre crops, sugarcane and spice crops.

The rate of application amount varies depending on, for example, the blending ratio of active ingredients, meteorological condition, dosage form, application time, application method, application place, insect-pests to be controlled and target crop, in ordinary cases.

The synergetic composition of the present invention is more effective than their individual counterparts. This allows a substantial reduction in the application rates of each of these active ingredients, while maintaining good efficacy. The decrease in application rates reduces treatment cost to the farmer and also eases the burden on the environment both from manufacturing waste and crop protection chemical residues.

The synergistic insecticidal composition of present invention provides a wide spectrum control of insect-pests, delays the emergence of the resistant strains, minimizes the risk of development of resistance and achieves effective and economical control of undesired or insect-pest.

The synergistic composition of the present invention provides a number of other advantages:
Increased efficacy in comparison to the other formulations tested during the trial.
Economically beneficial to the farmers as it provides better yield of the crop with reduction in the number of sprays.
Reduced possibility of hazards to the farmers due to occupational exposure because of reduction in the number of sprays.
Is storage stable.
Is non-phytotoxic.
Environmental friendly

Thus, from the foregoing description, it will be apparent to one of the person skilled in the art that many changes and modifications can be made thereto without departing from the spirit or scope of the invention as set forth in the description. Accordingly, it is not intended that the scope of the foregoing description be limited to the description set forth above, but rather that such description be construed as encompassing such features that reside in the present invention, including all the features and embodiments that would be treated as equivalents thereof by those skilled in the relevant art.

The embodiments of the present invention are more particularly described in the following examples that are intended as illustrations only, since numerous modifications and variations within the scope of the present invention will be apparent to those of skill in the art. Unless otherwise noted, all parts, percentages and ratios reported in the following examples are on a weight basis and all reagents used in the examples were obtained or are available from the chemical suppliers.

### Examples

The synergistic insecticidal composition of the present invention comprising Chlorantraniliprole, Flubendiamide and at least one compound selected from Pyriproxyfen, Diafenthiuron, Bifenthrin or Lambda cyhalothrin in the form of suspension concentrate (SC) is provided in table 1 to table 5 and in the form of suspo-emulsion (SE) is provided in table 6 to table 8. Table 9 to 11 provides the composition in the form of ZC.

The unit of each component of the composition are expressed in “% w/w” i.e. the percentage by weight, relative to the weight of the total solution or composition. The term “Q.S.” denotes quantity sufficient required to make 100% w/w formulation.

TABLE 1
Composition of Chlorantraniliprole, Flubendiamide and Pyriproxyfen SC

| | | Eg 1 | Eg 2 | Eg 3 | Eg 4 | Eg 5 |
|---|---|---|---|---|---|---|
| S. | | % By | % By | % By | % By | % By |
| No. | Ingredients | Weight | Weight | Weight | Weight | Weight |
| 1 | Chlorantraniliprole | 10 | 1 | 20 | 1 | 5 |
| 2 | Flubendiamide | 10 | 20 | 1 | 1 | 8 |
| 3 | Pyriproxyfen | 20 | 40 | 50 | 50 | 10 |
| 4 | Anti-freeze Agent | 5 | 5 | 5 | 5 | 7 |
| | (Propylene glycol) | | | | | |
| 5 | Dispersing Agent | 5 | 6 | 6 | 5 | 5 |
| | (Graft Copolymer) | | | | | |
| 6 | Wetting Agent | 3 | 4 | 4 | 3 | 3 |
| | (Non-ionic ethoxylate) | | | | | |
| 7 | Deformer (Dimethyl | 0.1 | 0.1 | 0.1 | 0.1 | 0.1 |
| | Polysiloxane emulsion) | | | | | |
| 8 | Biocide (Proxel GXL) | 0.1 | 0.1 | 0.1 | 0.1 | 0.1 |
| 9 | Thickener (Xanthan Gum) | 0.2 | 0.2 | 0.2 | 0.2 | 0.2 |
| 10 | Demineralized water | Q.S. to | Q.S. to | Q.S. to | Q.S. to | Q.S. to |
| | | make 100 | make 100 | make 100 | make 100 | make 100 |
| | Total | 100 | 100 | 100 | 100 | 100 |

TABLE 2
Composition of Chlorantraniliprole,
Flubendiamide and Diafenthiuron SC

| | | Eg 6 | Eg 7 | Eg 8 | Eg 9 |
|---|---|---|---|---|---|
| S. | | % By | % By | % By | % By |
| No. | Ingredients | Weight | Weight | Weight | Weight |
| 1 | Chlorantraniliprole | 3 | 1 | 20 | 1 |
| 2 | Flubendiamide | 5 | 20 | 2 | 1 |
| 3 | Diafenthiuron | 30 | 20 | 20 | 40 |
| 4 | Anti-freeze Agent | 5 | 5 | 5 | 5 |
| | (Propylene glycol) | | | | |
| 5 | Dispersing Agent | 5 | 5 | 5 | 5 |
| | (Graft Copolymer) | | | | |
| 6 | Wetting Agent | 3 | 3 | 3 | 3 |
| | (Non-ionic ethoxylate) | | | | |
| 7 | Deformer (Dimethyl | 0.1 | 0.1 | 0.1 | 0.1 |
| | Polysiloxane emulsion) | | | | |
| 8 | Biocide (Proxel GXL) | 0.1 | 0.1 | 0.1 | 0.1 |
| 9 | Thickener (Xanthan | 0.2 | 0.2 | 0.2 | 0.2 |
| | Gum) | | | | |
| 10 | Demineralized water | Q.S. to | Q.S. to | Q.S. to | Q.S. to |
| | | make | make | make | make |
| | | 100 | 100 | 100 | 100 |
| | Total | 100 | 100 | 100 | 100 |

TABLE 3
Composition of Chlorantraniliprole, Flubendiamide and Bifenthrin SC

| | | Eg 10 | Eg 11 | Eg 12 | Eg 13 | Eg 14 |
|---|---|---|---|---|---|---|
| S. | | % By | % By | % By | % By | % By |
| No. | Ingredients | Weight | Weight | Weight | Weight | Weight |
| 1 | Chlorantraniliprole | 6 | 1 | 20 | 10 | 10 |
| 2 | Flubendiamide | 10 | 5 | 2.5 | 1 | 20 |
| 3 | Bifenthrin | 16 | 20 | 30 | 30 | 5 |
| 4 | Anti-freeze Agent | 5 | 5 | 5 | 5 | 5 |
| | (Propylene glycol) | | | | | |
| 5 | Dispersing Agent | 5 | 5 | 5 | 5 | 5 |
| | (Graft Copolymer) | | | | | |
| 6 | Wetting Agent | 3 | 3 | 3 | 3 | 3 |
| | (Non-ionic ethoxylate) | | | | | |
| 7 | Deformer (Dimethyl | 0.1 | 0.1 | 0.1 | 0.1 | 0.1 |
| | Polysiloxane emulsion) | | | | | |
| 8 | Biocide (Proxel GXL) | 0.1 | 0.1 | 0.1 | 0.1 | 0.1 |
| 9 | Thickener (Xanthan Gum) | 0.2 | 0.2 | 0.2 | 0.2 | 0.2 |
| 10 | Demineralized water | Q.S. to | Q.S. to | Q.S. to | Q.S. to | Q.S. to |
| | | make 100 | make 100 | make 100 | make 100 | make 100 |
| | Total | 100 | 100 | 100 | 100 | 100 |

TABLE 4
Composition of Chlorantraniliprole, Flubendiamide and Lambda cyhalothrin SC

| | | Eg 15 | Eg 16 | Eg 17 | Eg 18 | Eg 19 | Eg 20 | Eg 21 |
|---|---|---|---|---|---|---|---|---|
| S. | | % By | % By | % By | % By | % By | % By | % By |
| No. | Ingredients | Weight | Weight | Weight | Weight | Weight | Weight | Weight |
| 1 | Chlorantraniliprole | 12 | 6 | 1 | 20 | 10 | 15 | 1 |
| 2 | Flubendiamide | 20 | 10 | 20 | 2 | 1 | 20 | 1 |
| 3 | Lambda-Cyhalothrin | 6 | 3 | 6 | 10 | 5 | 0.1 | 40 |
| 4 | Anti-freeze Agent | 5 | 5 | 5 | 5 | 7 | 5 | 5 |
| | (Propylene glycol) | | | | | | | |
| 5 | Dispersing Agent | 5 | 5 | 5 | 5 | 6 | 5 | 6 |
| | (Graft Copolymer) | | | | | | | |
| 6 | Wetting Agent | 3 | 3 | 3 | 3 | 3 | 3 | 4 |
| | (Non-ionic ethoxylate) | | | | | | | |
| 7 | Deformer (Dimethyl | 0.1 | 0.1 | 0.1 | 0.1 | 0.1 | 0.1 | 0.1 |
| | Polysiloxane emulsion) | | | | | | | |
| 8 | Biocide (Proxel GXL) | 0.1 | 0.1 | 0.1 | 0.1 | 0.1 | 0.1 | 0.1 |
| 9 | Thickener (Xanthan Gum) | 0.2 | 0.2 | 0.2 | 0.2 | 0.2 | 0.2 | 0.2 |
| 10 | Demineralized water | Q.S. to | Q.S. to | Q.S. to | Q.S. to | Q.S. to | Q.S. to | Q.S. to |
| | | make 100 | make 100 | make 100 | make 100 | make 100 | make 100 | make 100 |
| | Total | 100 | 100 | 100 | 100 | 100 | 100 | 100 |

### Process of Preparing Synergistic Insecticidal Composition of Present Invention in (SC) Form

Table 5 mentions active ingredients in technical grade whereas entries for active ingredients in table 1 to 4 are for 100% pure compounds. Particularly, the examples 1, 6, 10, 15 and 16 corresponds to column A to E in table 5.

TABLE 5
Quantities of active ingredients and raw material charged

| S. | | | Quantity(g) | | | | |
|---|---|---|---|---|---|---|---|
| No. | Ingredients | Function | A | B | C | D | E |
| 1 | Chlorantraniliprole | Active | 10.52 | 3.15 | 6.31 | 12.63 | 6.31 |
| | Technical (Basis of | ingredient | | | | | |
| | 95.0%) | | | | | | |
| 2 | Flubendiamide | Active | 10.52 | 5.26 | 10.52 | 21.05 | 10.52 |
| | Technical (Basis of | ingredient | | | | | |
| | 95.0%) | | | | | | |
| 3 | Pyriproxyfen | Active | 21.05 | — | | | — |
| | Technical (Basis of | ingredient | | | | | |
| | 95.0%) | | | | | | |
| 4 | Diafenthiuron | Active | — | 31.25 | — | — | — |
| | Technical (Basis of | ingredient | | | | | |
| | 96.0%) | | | | | | |
| 5 | Bifenthrin Technical | Active | — | — | 16.50 | | — |
| | (Basis of 97.0%) | ingredient | | | | | |
| 6 | Lambda cyhalothrin | Active | — | — | — | 6.31 | 3.15 |
| | Technical (Basis of | ingredient | | | | | |
| | 95.0%) | | | | | | |
| 7 | Graft copolymer | Dispersing | 5.00 | 5.00 | 5.00 | 5.00 | 5.00 |
| | | agent | | | | | |
| 8 | Non-ionic ethoxylate | Wetting | 3.00 | 3.00 | 3.00 | 3.00 | 3.00 |
| | | agent | | | | | |
| 9 | Dimethyl polysiloxane | Defoamer | 0.10 | 0.10 | 0.10 | 0.10 | 0.10 |
| | emulsion | | | | | | |
| 10 | Propylene glycol | Anti-freeze | 5.00 | 5.00 | 5.00 | 5.00 | 5.00 |
| | | agent | | | | | |
| 11 | Proxel GXL | Biocide | 0.10 | 0.10 | 0.10 | 0.10 | 0.10 |
| 12 | Xanthan gum | Thickener | 0.20 | 0.20 | 0.20 | 0.20 | 0.20 |
| 13 | Demineralized water | Solvent | 44.51 | 46.94 | 53.27 | 46.61 | 66.62 |
| | Total | | 100 | 100 | 100 | 100 | 100 |

The ingredients were weighed and taken as per Table 5. Demineralised water, Proxel GXL, dimethyl polysiloxane emulsion were taken. Then, propylene glycol, graft copolymer, Non-ionic ethoxylate were added and stirred well. To the mixture, Chlorantraniliprole, Flubendiamide and one of Pyriproxyfen, Diafenthiuron, Bifenthrin or Lambda cyhalothrin were added with stirring. The mixture was homogenized with high speed homogenizer to obtain homogeneous slurry. The slurry was wet grinded using a suitable bead mill/sand mill till required particle size was achieved. During wet grinding temperature was maintained between 25° ° C. to 30° C. After wet grinding, material was withdrawn through mill and water wash was given with remaining water and was withdrawn in the same container and mixed well. To the mixture, water solution of xanthan gum was added with low shear mixing stirrer to obtain the composition of present invention in SC form.

TABLE 6
Composition of Chlorantraniliprole, Flubendiamide and Pyriproxyfen SE

| | | Eg 22 | Eg 23 | Eg 24 | Eg 25 | Eg 26 |
|---|---|---|---|---|---|---|
| Sr. | | % by | % By | % By | % By | % By |
| No. | Ingredients | weight | Weight | Weight | Weight | Weight |
| 1 | Chlorantraniliprole | 10 | 1 | 20 | 1 | 5 |
| 2 | Flubendiamide | 10 | 20 | 1 | 1 | 8 |
| 3 | Pyriproxyfen | 20 | 40 | 50 | 50 | 10 |
| 4 | Dispersing agent | 3 | 3 | 3 | 3 | 3 |
| | (Acrylic Copolymer) | | | | | |
| 5 | Co-dispersant | 1.5 | 1 | 1.5 | 1.5 | 1.5 |
| | (Phosphate ester) | | | | | |
| 6 | Solvent (N-methyl-2- | 10 | 10 | 5 | 10 | 10 |
| | pyrrolidone) | | | | | |
| 7 | Co-solvent (Naphtha) | 2 | 2 | 2 | 2 | 2 |
| 8 | Emulsifier (Tristyryl | 4 | 4 | 4 | 4 | 4 |
| | phenol) | | | | | |
| 9 | Wetting agent (Non- | 2 | 2 | 2 | 2 | 2 |
| | ionice thoxylated) | | | | | |
| 10 | Anti-freeze agent | 5 | 5 | 5 | 5 | 5 |
| | (Propylene glycol) | | | | | |
| 11 | Defoamer (Silicon | 0.15 | 0.15 | 0.2 | 0.2 | 0.15 |
| | emulsion) | | | | | |
| 12 | Biocide (Antifungal | 0.15 | 0.15 | 0.15 | 0.15 | 0.15 |
| | agent) | | | | | |
| 13 | Thickener (Xanthan | 0.2 | 0.2 | 0.2 | 0.2 | 0.2 |
| | Gum) | | | | | |
| 14 | Demineralized Water | Q.S. to | Q.S. to | Q.S. to | Q.S. to | Q.S. to |
| | | make 100 | make 100 | make 100 | make 100 | make 100 |
| Total | | 100 | 100 | 100 | 100 | 100 |

TABLE 7
Composition of Chlorantraniliprole, Flubendiamide and Bifenthrin SE

| | | Eg 27 | Eg 28 | Eg 29 | Eg 30 | Eg 31 |
|---|---|---|---|---|---|---|
| Sr. | | % by | % By | % By | % By | % By |
| No. | Ingredients | weight | Weight | Weight | Weight | Weight |
| 1 | Chlorantraniliprole | 6 | 1 | 20 | 10 | 10 |
| 2 | Flubendiamide | 10 | 5 | 2.5 | 1 | 20 |
| 3 | Bifenthrin | 16 | 20 | 30 | 30 | 5 |
| 4 | Dispersing agent | 3 | 3 | 3 | 3 | 3 |
| | (Acrylic Copolymer) | | | | | |
| 5 | Co-dispersant | 1.5 | 2 | 2 | 2 | 2 |
| | (Phosphate ester) | | | | | |
| 6 | Solvent (N-methyl-2- | 12 | 15 | 15 | 15 | 10 |
| | pyrrolidone) | | | | | |
| 7 | Co-solvent (Naphtha) | 2 | 2 | 2 | 2 | 2 |
| 8 | Emulsifier (Tristyryl | 4 | 4 | 4 | 4 | 4 |
| | phenol) | | | | | |
| 9 | Wetting agent (Non- | 2 | 2 | 2 | 2 | 2 |
| | ionic ethoxylated) | | | | | |
| 10 | Anti-freeze agent | 5 | 5 | 5 | 5 | 5 |
| | (Propylene glycol) | | | | | |
| 11 | Defoamer (Silicon | 0.15 | 0.15 | 0.15 | 0.15 | 0.15 |
| | emulsion) | | | | | |
| 12 | Biocide (Antifungal | 0.15 | 0.15 | 0.15 | 0.15 | 0.15 |
| | agent) | | | | | |
| 13 | Thickener (Xanthan | 0.2 | 0.2 | 0.2 | 0.2 | 0.2 |
| | Gum) | | | | | |
| 14 | Demineralized Water | Q.S. to | Q.S. to | Q.S. to | Q.S. to | Q.S. to |
| | | make 100 | make 100 | make 100 | make 100 | make 100 |
| Total | | 100 | 100 | 100 | 100 | 100 |

### Process of Preparing Synergistic Insecticidal Composition of Present Invention i SE Form

Table 8 mentions active ingredients in technical grade whereas entries for active ingredients in table 6 and 7 are for 100% pure compounds. Particularly, examples 22 and 27 corresponds to column F to G in table 8.

TABLE 8
Quantities of active ingredients and raw material charged

| S. | | | Quantity (g) | |
|---|---|---|---|---|
| No. | Ingredients | Function | F | G |
| 1 | Chlorantraniliprole | Active | 10.52 | 6.31 |
| | Technical (95% Basis) | ingredient | | |
| 2 | Flubendiamide Technical | Active | 10.52 | 10.52 |
| | (95% Basis) | ingredient | | |
| 3 | Pyriproxyfen Technical | Active | 21.05 | — |
| | (95% Basis) | ingredient | | |
| 4 | Bifenthrin Technical | Active | — | 16.80 |
| | (95% Basis) | ingredient | | |
| 5 | Acrylic copolymer | Dispersing | 3.00 | 3.00 |
| | | agent | | |
| 6 | Phosphate ester | Co-dispersing | 1.50 | 1.50 |
| | | agent | | |
| 7 | N-methyl-2-pyrrolidone | Solvent | 10.00 | 12.00 |
| 8 | Naptha | Co-solvent | 2.00 | 2.00 |
| 9 | Tristyryl phenol | Emulsifier | 4.00 | 4.00 |
| 10 | Castor oil ethoxylate/ | Wetting | 2.00 | 2.00 |
| | Non-ionic ethoxylated | agent | | |
| 11 | Propylene glycol | Anti-freeze | 5.00 | 5.00 |
| | | agent | | |
| 12 | Silicon emulsion | Defoamer | 0.15 | 0.15 |
| 13 | Proxel GXL | Biocide | 0.15 | 0.15 |
| 14 | Xanthan gum | Thickener | 0.20 | 0.20 |
| 15 | Demineralized water | Solvent | 29.91 | 36.37 |
| Total | | | 100 | 100 |

All the ingredients were taken as per table 8. Proxel GXL, Silicon emulsion were diluted in demineralised water. Then propylene glycol, acrylic copolymer, phosphate ester non-ionic ethoxylated were added and stirred well. Then, chlorantraniliprole, flubendiamide were added for SC preparation with stirring and homogenized with high speed homogenizer having suitable RPM to obtain a homogeneous slurry. The homogeneous slurry was wet grinded in a suitable bead mill till required particle size was obtained. During wet grinding temperature was maintained between 25° ° C. to 30° C. After wet grinding, material was withdrawn through mill and water wash was given with remaining water and was withdrawn in the same container and mixed well. In another vessel, Pyriproxyfen/Bifenthrin was dissolved in N-methyl-2-pyrrolidone and naptha. Then tristyryl phenol was added and mixed in a high shear mixer and demineralized water was added to obtain EW/EC formulation. To the EW/EC preparation, the above SC preparation was added and mixed well to obtain homogeneous mixture. To the mixture, water solution of xanthan gum was added and stirred with low shear mixing stirrer to obtain the composition of present invention in SE form.

TABLE 9
Composition of Chlorantraniliprole,
Flubendiamide and Lambda-cyhalothrin ZC

| | | Eg 32 | Eg 33 |
|---|---|---|---|
| Sr. | | (% by | (% by |
| No. | Ingredients | weight) | weight) |
| 1 | Chlorantraniliprole | 12.00 | 6.00 |
| 2 | Flubendiamide | 20.00 | 10.00 |
| 3 | Lambda-cyhalothrin | 06.00 | 3.00 |
| 4 | Anti-freeze Agent (Propylene | 2-10 | 2-10 |
| | glycol/DEG/MEG) | | |
| 5 | Dispersing Agent (Amine salt | 2-10 | 2-10 |
| | of phosphate tristyryl phenol | | |
| | ethoxylated/Acrylic | | |
| | Copolymer/Graft copolymer) | | |
| 6 | Wetting Agent (Ethoxylated | 1-5 | 1-5 |
| | Polyarylphenol Phosphate | | |
| | Ester/Dioctyl sulphosuccinate/ | | |
| | Non-ionic ethoxylate) | | |
| 7 | Capsule forming Monomer I | 0.5-3.00 | 0.5-3.00 |
| | (Polyisocyanate/Toluene | | |
| | Diisocyante/Tri-isocyanate) | | |
| 8 | Capsule forming Monomer II | 0.2-2.00 | 0.2-2.00 |
| | (Ethylenediamine/ | | |
| | Diethylenetetramine/ | | |
| | hexaethylene diamine) | | |
| 9 | Solvent | 05-15.00 | 05-15.00 |
| | (Naphtha, Xylene, | | |
| | Decanamide, solvent C-IX) | | |
| 10 | Emulsifier (Non-ionic | 02-05.00 | 02-05.00 |
| | ethoxylated emulsifier, | | |
| | Blend of nonionic-anionic | | |
| | emulsifiers (proprietary blend) | | |
| 11 | Defoamer (Dimethyl | 00.01-00.50 | 00.01-00.50 |
| | Polysiloxane emulsion) | | |
| 12 | Biocide (Proxel GXL/ | 00.01-00.50 | 00.01-00.50 |
| | Formaldehyde) | | |
| 13 | Thickener (Xanthan Gum) | 00.01-00.50 | 00.01-00.50 |
| 14 | Demineralized water | Q.S. to | Q.S. to |
| | | make 100 | make 100 |
| | Total | 100.00 | 100.00 |

### Process for the Preparation of Chlorantraniliprole, Flubendiamide and Lambda-Cyhalothrin ZC

### Step-1 Process for the Preparation of SC Formulation Comprising Chlorantraniliprole and Flubendiamide

The ingredients were weighed as per Table 10.

TABLE 10

| Sr. | | Quantity | Quantity |
|---|---|---|---|
| No. | Ingredients | (g) | (g) |
| 1 | Chlorantraniliprole Technical (Basis of 95.0%) | 12.63 | 6.31 |
| 2 | Flubendiamide Technical (Basis of 95.0%) | 21.00 | 10.52 |
| 3 | Anti-freeze Agent (Propylene glycol) | 5.00 | 5.00 |
| 4 | Dispersing Agent (Graft Copolymer) | 5.00 | 5.00 |
| 5 | Wetting Agent (Non-ionic ethoxylate) | 3.00 | 3.00 |
| 6 | Defoamer (Dimethyl Polysiloxane emulsion) | 00.10 | 00.10 |
| 7 | Biocide (Proxel GXL) | 00.10 | 00.10 |
| 8 | Thickener (Xanthan Gum) | 00.20 | 00.20 |
| 9 | Demineralized water | 52.97 | 69.77 |
| | Total | 100.00 | 100.00 |

Demineralised water, Proxel GXL and Dimethyl Polysiloxane emulsion were taken. Then, propylene glycol, graft copolymer, non-ionic ethoxylate were added and stirred well. To the mixture, chlorantraniliprole, flubendiamide were added with stirring. The mixture was homogenized with high speed homogenizer to obtain homogeneous slurry. The slurry was wet grinded using a suitable bead mill/sand mill till required particle size was achieved. During wet grinding temperature was maintained between 25° ° C. to 30° ° C. After wet grinding, material was withdrawn through mill and water wash was given with remaining water and was added in the same container and mixed well. To the material was added water solution of thickener under low stirring to obtain the composition comprising chlorantraniliprole and flubendiamide in SC form.

### Step-2 Process for the Preparation of CS Formulation Comprising Lambda Cyhalothrin

The preparation of CS formulation involves two phases: organic and aqueous phase. All the ingredients were weighed and taken as per the below Table 11.

TABLE 11

| Sr. | | Quantity | Quantity |
|---|---|---|---|
| No. | Ingredients | (g) | (g) |
| 1 | Lambda cyhalothrin Technical (Basis of 95.0%) | 6.31 | 3.15 |
| 2 | Capsule forming Monomer I (Diphenylmethane | 3.00 | 3.00 |
| | diisocyanate)) | | |
| 3 | Capsule forming Monomer II | 1.00 | 1.00 |
| | (Diethylenetetramine) | | |
| 4 | Solvent (solvent C-IX) | 5.00 | 5.00 |
| 5 | Emulsifier (Non-ionic ethoxylated emulsifier) | 5.00 | 5.00 |
| 6 | Defoamer (Dimethyl Polysiloxane emulsion) | 0.2 | 0.2 |
| 7 | Demineralized water | 79.49 | 82.65 |
| Total | | 100 | 100 |

1. Organic phase: Solvent C-IX was taken and Lambda cyhalothrin was added and dissolved to obtain a clear solution. Diphenylmethane diisocyanate was then added and stirred well to obtain a homogenous mixture.

2. Aqueous Phase: Water, Dimethyl Polysiloxane emulsion, non-ionic ethoxylated emulsifier were taken and mixed well to obtain aqueous phase.

3. The organic phase prepared above was slowly added into aqueous phase with continuous stirring. Both phases were mixed using high speed homogeniser at 2000-2500 rpm to obtain a fine emulsion droplet size. Emulsion droplet size was monitored during process until particle size D-90<50 micron was achieved. The mixture was transferred to two neck round bottomed flask and kept in a water bath at 50° ° C. with stirrer and thermometer pocket. The mixture was stirred for 1 hour, then Diethylenetetramine was added and was continuously mixed at 500-1000 rpm for 2 hours to get uniform CS formulation.

Step 3: The CS formulation obtained in step 2 was cooled then mixed with SC formulation obtained in step 1 to obtain ZC formulation comprising chlorantraniliprole, Flubendiamide and Lambda-cyhalothrin.

### Bio-Efficacy

Two field experiments A and B were conducted to evaluate the efficacy of the composition of the present invention. In experiment A, efficacy of combination of Chlorantraniliprole+Flubendiamide+Diafenthiuron/Pyriproxyfen on the control of bollworm complex and white fly in cotton crop was evaluated. In experiment B, efficacy of combination of Chlorantraniliprole+Flubendiamide+Bifenthrin/Lambda-cyhalothrin on the control of bollworm complex in cotton crop was evaluated.

### Field Experiment A

A field experiment was conducted on cotton crop (variety: H777) to evaluate the control of bollworm complex and white fly with solo formulations, binary combinations and ternary composition of the present invention as per the details provided in Table 12 and Table 13. The experiment was laid out in Randomized Block Design (RBD). The plot size was 10m×10m and the spacing was 90 cm×45 cm. All the recommended agronomic practices were followed throughout the cropping period. Applications were made with a domestic sprayer fitted with a pressure regulator and hollow cone nozzle. One single application was made using hollow cone nozzle using spray fluid 500 l/ha at an interval of 50 days after sowing. The various treatments were sprayed on cotton crop to evaluate the control of bollworm complex and white fly. All treatments were replicated thrice. Based on various doses, weighed quantity of test products were dissolved in 5 litres of water/treatment and sprayed uniformly.

Observations were made at 5, 10, 15 and 30 days after application (DAA).

% ball damage reduction over control was calculated using Abbott's formula as below:

$$\begin{matrix}Corrected \% \\ Pod / fruit / ball / square / loculi \\ Damage reduction\end{matrix} = 1 - ( \frac{n in T after treatment}{n in Co after treatment} ) \times 100$$

where, n=no. of damaged pods/fruits/balls/squares/loculi; T=Treated; Co=Control

(Reference: Abbott, W. S. (1925). A method of computing the effectiveness of an insecticide. J. Econ. Entomol.; 18:265-267)

The population of whiteflies was recorded on a suitable number of randomly selected three leaves per plant per replication. The post-treatment population of whitefly, are taken at intervals i.e. 10, 15 and 30 days after application (DAA). % reduction in whitefly population over control was calculated using Abbott's formula. The cotton yield (Kg/ha) was recorded after harvest of crop. The observations on phytotoxicity effect of test insecticides were recorded during crop period.

TABLE 12
Efficacy of combination of Chlorantraniliprole +
Flubendiamide + Pyriproxyfen on Bollworm Complex

| | | Dose | Dose | % Damage (Cotton Bollworm Complex) | | | | | % reduction |
|---|---|---|---|---|---|---|---|---|---|
| S. | | Formulation | a.i./ha | 5 | 10 | 15 | 30 | | against |
| No. | Treatment | (g/ml/ha) | (g) | DAA | DAA | DAA | DAA | Mean | control |
| 1 | Chlorantraniliprole | 300 ml | 30 + | 4.90 | 5.20 | 6.10 | 6.00 | 5.55 | 81.91 |
| | 10% + Flubendiamide | | 30 + 60 | (12.79) | (13.18) | (14.30) | (14.18) | (13.63) | |
| | 10% + Pyriproxyfen | | | | | | | | |
| | 20% SC | | | | | | | | |
| 2 | Flubendiamide 20% | 150 + 150 | 30 + 30 | 10.60 | 11.80 | 14.20 | 15.90 | 13.13 | 57.21 |
| | WG + | | | (19.00) | (20.09) | (22.14) | (23.50) | (21.24) | |
| | Chlorantraniliprole | | | | | | | | |
| | 18.5% SC | | | | | | | | |
| 3 | Flubendiamide 20% | 150 + 600 | 30 + 60 | 18.60 | 19.50 | 23.00 | 25.00 | 21.53 | 29.83 |
| | WG + Pyriproxyfen | | | (25.55) | (26.21) | (28.66) | (30.00) | (27.65) | |
| | 10% EC | | | | | | | | |
| 4 | Chlorantraniliprole | 150 + 600 | 30 + 60 | 14.00 | 15.00 | 17.40 | 19.00 | 16.35 | 46.70 |
| | 18.5% SC + | | | (21.97) | (22.79) | (24.65) | (25.84) | (23.85) | |
| | Pyriproxyfen 10% | | | | | | | | |
| | EC | | | | | | | | |
| 5 | Flubendiamide 20% | 150 | 30 | 16.00 | 14.90 | 18.70 | 22.10 | 17.93 | 41.56 |
| | WG | | | (23.58) | (22.71) | (25.62) | (28.04) | (25.05) | |
| 6 | Chlorantraniliprole | 150 | 30 | 13.00 | 13.50 | 16.50 | 19.70 | 15.68 | 48.90 |
| | 18.5% SC | | | (21.13) | (21.56) | (23.97 | (26.35) | (23.33) | |
| 7 | Pyriproxyfen 10% | 600 | 60 | 19.80 | 23.80 | 27.70 | 30.70 | 25.50 | 16.87 |
| | EC | | | (26.42) | (29.20) | (31.76) | (33.65) | (30.33) | |
| 8 | Control | — | — | 24.00 | 30.00 | 32.80 | 35.90 | 30.68 | — |
| | | | | (29.33) | (33.21) | (34.94) | (36.81) | (33.63) | |
| | SEm± | — | — | 0.451 | 0.583 | 0.631 | 0.698 | 0.588 | — |
| | CD@5% | — | — | 1.383 | 1.785 | 1.933 | 2.138 | 1.801 | — |

Figure in parenthesis represents arc sin transformed value;
SEm±: Standard errors of means;
CD@5%: Critical Difference

TABLE 13
Efficacy of combination of Chlorantraniliprole + Flubendiamide + Pyriproxyfen on white fly and yield data

| | | Dose | Dose | No of white fly/3 leaf | | | | % reduction | |
|---|---|---|---|---|---|---|---|---|---|
| S. | | Formulation | a.i./ha | 10 | 15 | 30 | | against | Yield |
| No. | Treatment | (g/ml/ha) | (g) | DAA | DAA | DAA | Mean | control | (kg/ha) |
| 1 | Chlorantraniliprole | 300 ml | 30 + | 1.67 | 2.33 | 3.67 | 1.92 | 84.13 | 1108 |
| | 10% + Flubendiamide | | 30 + 60 | (1.47) | (1.68) | (2.04) | (1.56) | | |
| | 10% + Pyriproxyfen | | | | | | | | |
| | 20% SC | | | | | | | | |
| 2 | Flubendiamide 20% | 150 + 150 | 30 + 30 | 6.33 | 8.00 | 11.33 | 6.42 | 46.91 | 880 |
| | WG + | | | (2.61) | (2.92) | (3.44) | (2.63) | | |
| | Chlorantraniliprole | | | | | | | | |
| | 18.5% SC | | | | | | | | |
| 3 | Flubendiamide 20% | 150 + 600 | 30 + 60 | 5.00 | 5.67 | 8.00 | 4.67 | 61.37 | 861 |
| | WG + Pyriproxyfen | | | (2.35) | (2.48) | (2.92) | (2.27) | | |
| 4 | 10% EC | 150 + 600 | 30 + 60 | 4.67 | 5.00 | 7.67 | 4.34 | 64.12 | 995 |
| | Chlorantraniliprole | | | | | | | | |
| | 18.5% SC + | | | (2.27) | (2.35) | (2.86) | (2.20) | | |
| | Pyriproxyfen 10% | | | | | | | | |
| | EC | | | | | | | | |
| 5 | Flubendiamide 20% | 150 | 30 | 9.33 | 12.00 | 14.67 | 9.00 | 25.51 | 812 |
| | WG | | | (3.14) | (3.54) | (3.89) | (3.08) | | |
| 6 | Chlorantraniliprole | 150 | 30 | 9.33 | 12.00 | 13.67 | 8.75 | 27.58 | 880 |
| | 18.5% SC | | | (3.14) | (3.54) | (3.76) | (3.04) | | |
| 7 | Pyriproxyfen 10% | 600 | 60 | 5.00 | 6.33 | 8.00 | 4.83 | 60.00 | 851 |
| | EC | | | (2.35) | (2.61) | (2.92) | (2.31) | | |
| 8 | Control | — | — | 11.33 | 15.67 | 21.33 | 12.08 | — | 546 |
| | | | | (3.44) | (4.02) | (4.67) | (3.55) | | |
| | SEm± | — | — | 0.242 | 0.340 | 0.419 | 0.249 | — | 12.288 |
| | CD@5% | — | — | 0.742 | 143 | 1.282 | 0.762 | — | 37.631 |

Figure in parenthesis represents arc sin transformed value;
SEm±: Standard errors of means;
CD@5%: Critical Difference

TABLE 14
Bio-efficacy of combination of Chlorantraniliprole +
Flubendiamide + Diafenthiuron on Bollworm Complex

| | | Dose | Dose | % Damage (Cotton Bollworm Complex) | | | | | % reduction |
|---|---|---|---|---|---|---|---|---|---|
| S. | | Formulation | a.i./ha | 5 | 10 | 15 | 30 | | against |
| No. | Treatment | (g/ml/ha) | (g) | DAA | DAA | DAA | DAA | Mean | control |
| 1 | Chlorantraniliprole | 1000 ml | 30 + | 5.20 | 5.50 | 6.40 | 6.30 | 5.85 | 80.93 |
| | 3% + Flubendiamide | | 50 + 300 | (13.18) | (13.56) | (14.65) | (14.54) | (14.00) | |
| | 5% + Diafenthiuron | | | | | | | | |
| | 30% SC | | | | | | | | |
| 2 | Flubendiamide 20% | 250 + 150 | 50 + 30 | 9.20 | 10.50 | 13.00 | 14.50 | 11.80 | 61.53 |
| | WG + | | | (17.66) | (18.91) | (21.13) | (22.38) | (20.09) | |
| | Chlorantraniliprole | | | | | | | | |
| | 18.5% SC | | | | | | | | |
| 3 | Flubendiamide 20% | 250 + 600 | 50 + 300 | 18.40 | 19.60 | 22.50 | 24.80 | 21.33 | 30.48 |
| | WG + Diafenthiuron | | | (25.40) | (26.28) | (28.32) | (29.87) | (27.51) | |
| | 50% WP | | | | | | | | |
| 4 | Chlorantraniliprole | 150 + 600 | 30 + 300 | 14.70 | 15.80 | 18.30 | 20.00 | 17.20 | 43.93 |
| | 18.5% SC + | | | (22.54) | (23.42) | (25.33) | (26.57) | (24.50) | |
| | Diafenthiuron 50% | | | | | | | | |
| | WP | | | | | | | | |
| 5 | Flubendiamide 20% | 250 | 50 | 14.80 | 13.20 | 17.50 | 21.00 | 16.63 | 45.80 |
| | WG | | | (22.63) | (21.30) | (24.73) | (27.27) | (24.07) | |
| 6 | Chlorantraniliprole | 150 | 30 | 13.00 | 13.50 | 16.50 | 19.70 | 15.68 | 48.90 |
| | 18.5% SC | | | (21.13) | (21.56) | (23.97) | (26.35) | (23.33) | |
| 7 | Diafenthiuron 50% | 600 | 300 | 20.80 | 25.10 | 29.20 | 32.30 | 26.85 | 12.47 |
| | WP | | | (27.13) | (30.07) | (32.71) | (34.63) | (31.21) | |
| 8 | Control | — | — | 24.00 | 30.00 | 32.80 | 35.90 | 30.68 | — |
| | | | | (29.33) | (33.21) | (34.94) | (36.81) | (33.63) | |
| | SEm | — | — | 0.465 | 0.608 | 0.651 | 0.719 | 0.608 | — |
| | CD | — | — | 1.426 | 1.862 | 1.993 | 2.201 | 1.862 | — |

Figure in parenthesis represents arc sin transformed value;
SEm±: Standard errors of means;
CD@5%: Critical Difference

TABLE 15
Bio-efficacy of combination of Chlorantraniliprole + Flubendiamide + Diafenthiuron on white fly and yield data

| | | Dose | Dose | No of white fly/3 leaf | | | | % reduction | |
|---|---|---|---|---|---|---|---|---|---|
| S. | | Formulation | a.i./ha | 10 | 15 | 30 | | against | Yield |
| No. | Treatment | (g/ml/ha) | (g) | DAA | DAA | DAA | Mean | control | (kg/ha) |
| 1 | Chlorantraniliprole | 1000 ml | 30 + | 2.33 | 3.00 | 4.33 | 2.42 | 80.01 | 1091 |
| | 3% + Flubendiamide | | 50 + 300 | (1.68) | (1.87) | (2.20) | (1.71) | | |
| | 5% + Diafenthiuron | | | | | | | | |
| | 30% SC | | | | | | | | |
| 2 | Flubendiamide 20% | 250 + 150 | 50 + 30 | 5.67 | 7.33 | 10.00 | 5.75 | 52.41 | 928 |
| | WG + | | | (2.48) | (2.80) | (3.24) | (2.50) | | |
| | Chlorantraniliprole | | | | | | | | |
| | 18.5% SC | | | | | | | | |
| 3 | Flubendiamide 20% | 250 + 600 | 50 + 300 | 4.67 | 5.67 | 8.00 | 4.59 | 62.05 | 897 |
| | WG + Diafenthiuron | | | (2.27) | (2.48) | (2.92) | (2.26) | | |
| | 50% WP | | | | | | | | |
| 4 | Chlorantraniliprole | 150 + 600 | 30 + 300 | 5.33 | 6.33 | 8.33 | 5.00 | 58.64 | 980 |
| | 18.5% SC + | | | (2.41) | (2.61) | (2.97) | (2.35) | | |
| | Diafenthiuron 50% | | | | | | | | |
| | WP | | | | | | | | |
| 5 | Flubendiamide 20% | 250 | 50 | 8.00 | 10.00 | 12.33 | 7.58 | 37.24 | 860 |
| | WG | | | (2.92) | (3.24) | (3.58) | (2.84) | | |
| 6 | Chlorantraniliprole | 150 | 30 | 9.33 | 12.00 | 13.67 | 8.75 | 27.58 | 880 |
| | 18.5% SC | | | (3.14) | (3.54) | (3.76) | (3.04) | | |
| 7 | Diafenthiuron 50% | 600 | 300 | 5.67 | 8.67 | 9.67 | 6.00 | 50.32 | 809 |
| | WP | | | (2.48) | (3.03) | (3.19) | (2.55) | | |
| 8 | Control | — | — | 11.33 | 15.67 | 21.33 | 12.08 | — | 546 |
| | | | | (3.44) | (4.02) | (4.67) | (3.55) | | |
| | SEm | — | — | 0.218 | 0.306 | 0.381 | 0.225 | — | 12.036 |
| | CD | — | — | 0.668 | 0.937 | 1.168 | 0.689 | — | 36.861 |

Figure in parenthesis represents square root transformed value;
SEm±: Standard errors of means;
CD 5%: Critical Difference

TABLE 16
Phytotoxic effect of combination of Chlorantraniliprole +
Flubendiamide + Pyriproxyfen/Diafenthiuron

| | | | | | Vein | |
|---|---|---|---|---|---|---|
| Treatments | Dose/ha | Epinasty | Hyponasty | Necrosis | clearing | Wilting |
| Chlorantraniliprole 10% + | 300 | 0 | 0 | 0 | 0 | 0 |
| Flubendiamide 10% + | ml/ha | | | | | |
| Pyriproxyfen 20% SC | | | | | | |
| Chlorantraniliprole 10% + | 450 | 0 | 0 | 0 | 0 | 0 |
| Flubendiamide 10% + | ml/ha | | | | | |
| Pyriproxyfen 20% SC | | | | | | |
| Chlorantraniliprole 10% + | 600 | 0 | 0 | 0 | 0 | 0 |
| Flubendiamide 10% + | ml/ha | | | | | |
| Pyriproxyfen 20% SC | | | | | | |
| Chlorantraniliprole 3% + | 1000 | 0 | 0 | 0 | 0 | 0 |
| Flubendiamide 5% + | ml/ha | | | | | |
| Diafenthiuron 30% SC | | | | | | |
| Chlorantraniliprole 3% + | 1500 | 0 | 0 | 0 | 0 | 0 |
| Flubendiamide 5% + | ml/ha | | | | | |
| Diafenthiuron 30% SC | | | | | | |
| Chlorantraniliprole 3% + | 2000 | 0 | 0 | 0 | 0 | 0 |
| Flubendiamide 5% + | ml/ha | | | | | |
| Diafenthiuron 30% SC | | | | | | |
| Control | — | 0 | 0 | 0 | 0 | 0 |

0-No Phyto-toxicity
10-Complete kill the plant

### Field Experiment B− to Evaluate the Effect of Chlorantraniliprole+Flubendiamide+Bifenthrin/Lambda-Cyhalothrin on Bollworm Complex in Cotton Crop

A field experiment was conducted on cotton crop (variety: H777) to evaluate the control of bollworm complex with solo formulations, binary combinations and ternary composition of the present invention as per the details provided in Table 17 and Table 18.

The experiment was laid out in Randomized Block Design (RBD). The plot size was 10m×10m and the spacing was 90 cm×45 cm. All the recommended agronomic practices were followed throughout the cropping period. Applications were made with a domestic sprayer fitted with a pressure regulator and hollow cone nozzle. One single application was made using hollow cone nozzle using spray fluid 5001/ha at an interval of 56 days after sowing. The various treatments were sprayed on cotton crop to evaluate the control of bollworm complex. All treatments were replicated thrice. Based on various doses, weighed quantity of test products were dissolved in 5 litres of water/treatment and sprayed uniformly. Observations were made at 5, 10, 15 and 30 days after application (DAA). % ball damage reduction over control was calculated using Abbott's formula. The cotton yield (Kg/ha) was recorded after harvest of crop.

The observations on phytotoxicity effect of test insecticides were recorded during crop period.

TABLE 17
Eefficacy of combination of Chlorantraniliprole + Flubendiamide + Bifenthrin on Bollworm Complex

| | | Dose | Dose | % Damage (Cotton Bollworm Complex) | | | | | % reduction | |
|---|---|---|---|---|---|---|---|---|---|---|
| S. | | Formulation | a.i./ha | 5 | 10 | 15 | 30 | | against | Yield |
| No. | Treatment | (g/ml/ha) | (g) | DAA | DAA | DAA | DAA | Mean | control | (kg/ha) |
| 1 | Chlorantraniliprole | 500 ml | 30 + | 3.90 | 4.10 | 4.80 | 4.70 | 4.38 | 85.85 | 1146 |
| | 6% + Flubendiamide | | 50 + 80 | (11.39) | (11.68) | (12.66) | (12.52) | (12.08) | | |
| | 10% + Bifenthrin | | | | | | | | | |
| | 16% SC | | | | | | | | | |
| 2 | Flubendiamide 20% | 250 + 150 | 50 + 30 | 9.40 | 10.30 | 12.80 | 14.90 | 11.85 | 61.68 | 960 |
| | WG + | | | (17.85) | (18.72) | (20.96) | (22.71) | (20.14) | | |
| | Chlorantraniliprole | | | | | | | | | |
| | 18.5% SC | | | | | | | | | |
| 3 | Flubendiamide 20% | 250 + 800 | 50 + 80 | 12.80 | 13.60 | 15.60 | 17.20 | 14.80 | 52.14 | 910 |
| | WG + Bifenthrin | | | (20.96) | (21.64) | (23.26) | (24.50) | (22.63) | | |
| | 10% EC | | | | | | | | | |
| 4 | Chlorantraniliprole | 150 + 800 | 30 + 80 | 10.20 | 11.00 | 12.70 | 13.90 | 11.95 | 61.36 | 963 |
| | 18.5% SC + | | | (18.63) | (19.37) | (20.88) | (21.89) | (20.22) | | |
| | Bifenthrin 10% EC | | | | | | | | | |
| 5 | Flubendiamide 20% | 250 | 50 | 14.60 | 13.50 | 17.90 | 20.80 | 16.70 | 46.00 | 894 |
| | WG | | | (22.46) | (21.56) | (25.03) | (27.13) | (24.12) | | |
| 6 | Chlorantraniliprole | 150 | 30 | 12.80 | 13.40 | 16.70 | 19.50 | 15.60 | 49.56 | 910 |
| | 18.5% SC | | | (20.96) | (21.47) | (24.12) | (26.21) | (23.26) | | |
| 7 | Bifenthrin 10% EC | 800 | 80 | 16.80 | 23.10 | 25.20 | 27.30 | 23.10 | 25.30 | 788 |
| | | | | (24.20) | (28.73) | (30.13) | (31.50) | (28.73) | | |
| 8 | Control | — | — | 24.50 | 29.90 | 32.50 | 36.80 | 30.93 | — | 672 |
| | | | | (29.67) | (33.15) | (34.76) | (37.35) | (33.79) | | |
| | SEm± | — | — | 0.459 | 0.613 | 0.642 | 0.730 | 0.607 | — | 7.991 |
| | CD@5% | — | — | 1.406 | 1.877 | 1.966 | 2.235 | 1.860 | — | 24.473 |

Figure in parenthesis represents arc sin transformed value;
SEm±: Standard errors of means;
CD@5%: Critical Difference

TABLE 18
Efficacy of combination of Chlorantraniliprole + Flubendiamide + Lambda cyhalothrin on Bollworm Complex

| | | Dose | Dose | % Damage (Cotton Bollworm Complex) | | | | | % reduction | |
|---|---|---|---|---|---|---|---|---|---|---|
| S. | | Formulation | a.i./ha | 5 | 10 | 15 | 30 | | against | Yield |
| No. | Treatment | (g/ml/ha) | (g) | DAA | DAA | DAA | DAA | Mean | control | (kg/ha) |
| 1 | Chlorantraniliprole | 250 ml | 30 + | 3.10 | 3.50 | 3.80 | 4.30 | 3.68 | 88.12 | 1170 |
| | 12% + lubendiamide | | 50 + 15 | (10.14) | (10.78) | (11.24) | (11.97) | (11.06) | | |
| | 20% + Lambda- | | | | | | | | | |
| | Cyhalothrin 6% ZC | | | | | | | | | |
| 2 | Chlorantraniliprole | 500 ml | 30 + | 3.70 | 3.90 | 4.40 | 5.00 | 4.25 | 86.26 | 1149 |
| | 6% + Flubendiamide | | 50 + 15 | (11.09) | (11.39) | (12.11) | (12.92) | (11.90) | | |
| | 10% + Lambda- | | | | | | | | | |
| | Cyhalothrin 3% SC | | | | | | | | | |
| 3 | Flubendiamide 20% | 250 + 150 | 50 + 30 | 9.40 | 10.30 | 12.80 | 14.90 | 11.85 | 61.68 | 960 |
| | WG + | | | (17.85) | (18.72) | (20.96) | (22.71) | (20.14) | | |
| | Chlorantraniliprole | | | | | | | | | |
| | 18.5% SC | | | | | | | | | |
| 4 | Flubendiamide 20% | 250 + 300 | 50 + 15 | 11.40 | 12.10 | 13.90 | 15.40 | 13.20 | 57.32 | 936 |
| | WG + Lambda | | | (19.73) | (20.36) | (21.89) | (23.11) | (21.30) | | |
| | cyhalothrin 5% EC | | | | | | | | | |
| 5 | Chlorantraniliprole | 150 + 300 | 30 + 15 | 9.10 | 9.80 | 11.30 | 12.40 | 10.65 | 65.56 | 1013 |
| | 18.5% SC + Lambda | | | (17.56) | (18.24) | (19.64) | (20.62) | (19.05) | | |
| | cyhalothrin 5% EC | | | | | | | | | |
| 6 | Flubendiamide 20% | 250 | 50 | 14.60 | 13.50 | 17.90 | 20.80 | 16.70 | 46.00 | 894 |
| | WG | | | (22.46) | (21.56) | (25.03) | (27.13) | (24.12) | | |
| 7 | Chlorantraniliprole | 150 | 30 | 12.80 | 13.40 | 16.70 | 19.50 | 15.60 | 49.56 | 910 |
| | 18.5% SC | | | (20.96) | (21.47) | (24.12) | (26.21) | (23.26) | | |
| 8 | Lambda cyhalothrin | 300 | 15 | 15.00 | 20.60 | 22.50 | 24.40 | 20.63 | 33.31 | 845 |
| | 5% EC | | | (22.79 | (26.99) | (28.32) | (29.60) | (27.01) | | |
| 9 | Control | — | — | 24.50 | 29.90 | 32.50 | 36.80 | 30.93 | — | 672 |
| | | | | (29.67) | (33.15) | (34.76) | (37.35) | (33.79) | | |
| | SEm± | — | — | 0.494 | 0.625 | 0.678 | 0.764 | 0.637 | — | 7.472 |
| | CD@5% | — | — | 1.493 | 1.889 | 2.050 | 2.311 | 1.927 | — | 22.593 |

Figure in parenthesis represents arc sin transformed value;
SEm±: Standard errors of means;
CD@5%: Critical Difference

It is evident from the above tables that the composition of the present invention gave good control of bollworm complex and higher yield as compared to the reference products.

TABLE 19
Phytotoxic effect of combination of Chlorantraniliprole +
Flubendiamide + Bifenthin/Lambda-Cyhalothrin

| | | | | | Vein | |
|---|---|---|---|---|---|---|
| Treatments | Dose/ha | Epinasty | Hyponasty | Necrosis | clearing | Wilting |
| Chlorantraniliprole 6% + | 500 | 0 | 0 | 0 | 0 | 0 |
| Flubendiamide 10% + | ml/ha | | | | | |
| Bifenthrin 16% SC | | | | | | |
| Chlorantraniliprole 6% + | 750 | 0 | 0 | 0 | 0 | 0 |
| Flubendiamide 10% + | ml/ha | | | | | |
| Bifenthrin 16% SC | | | | | | |
| Chlorantraniliprole 6% + | 1000 | 0 | 0 | 0 | 0 | 0 |
| Flubendiamide 10% + | ml/ha | | | | | |
| Bifenthrin 16% SC | | | | | | |
| Chlorantraniliprole 12% + | 250 | 0 | 0 | 0 | 0 | 0 |
| Flubendiamide 20% + | ml/ha | | | | | |
| Lambda-Cyhalothrin 6% ZC | | | | | | |
| Chlorantraniliprole 6% + | 500 | 0 | 0 | 0 | 0 | 0 |
| Flubendiamide 10% + | ml/ha | | | | | |
| Lambda-Cyhalothrin 3% SC | | | | | | |
| Chlorantraniliprole 12% + | 500 | 0 | 0 | 0 | 0 | 0 |
| Flubendiamide 20% + | ml/ha | | | | | |
| Lambda-Cyhalothrin 6% ZC | | | | | | |
| Chlorantraniliprole 6% + | 1000 | 0 | 0 | 0 | 0 | 0 |
| Flubendiamide 10% + | ml/ha | | | | | |
| Lambda-Cyhalothrin 3% SC | | | | | | |
| Control | — | 0 | 0 | 0 | 0 | 0 |

0-No Phyto-toxicity
10-Complete kill the plant

### Evaluation of Synergistic Effect

A synergistic effect exists whenever the action of an active ingredient combination is greater than the sum of the actions of the individual components. Synergism was calculated by using Colby's method, Weeds, vol. 15 No. 1(January 1967), pp. 20-2.

The synergistic action expected for a given combination of three active components can be calculated as follows:

$$E = ( X + Y + Z ) - \frac{( XY + YZ + XZ )}{100} + \frac{XYZ}{10000}$$

Where:

E represents expected percentage of control for the combination of the three active ingredients at defined doses (for example equal to x, y and z respectively),
X is the percentage of control observed by the compound (I) at a defined dose (equal to x),
Y is the percentage of control observed by the compound (II) at a defined dose (equal to y),
Z is the percentage of control observed by the compound (III) at a defined dose (equal to z).
If observed control of the combination >Expected control, the combination is synergistic
If observed control of the combination <Expected control, the combination is antagonistic
If observed control of the combination=Expected control, the combination is additive

TABLE 20
Synergistic effect of Chlorantraniliprole + Flubendiamide + Pyriproxyfen

| | | | | % reduction | | | |
|---|---|---|---|---|---|---|---|
| | | | | against | | | |
| | | | | control | Expected % | | Expected % |
| | | | | (Bollworm | control (By | % reduction | control (By |
| | | Dose | Dose | Complex) - | applying | against | applying |
| S. | | Formulation | a.i./ha | observed | Colby's | control | Colby's |
| No. | Treatment | (g/ml/ha) | (g) | control | formula) | (white fly) | formula) |
| 1 | Chlorantraniliprole | 300 ml | 30 + | 81.91 | 75.18 | 84.13 | 78.42 |
| | 10% + Flubendiamide | | 30 + 60 | | | | |
| | 10% + Pyriproxyfen | | | | | | |
| | 20% SC | | | | | | |
| 2 | Flubendiamide 20% | 150 | 30 | 41.56 | | 25.51 | |
| | WG | | | | | | |
| 3 | Chlorantraniliprole | 150 | 30 | 48.90 | | 27.58 | |
| | 18.5% SC | | | | | | |
| 4 | Pyriproxyfen 10% | 600 | 60 | 16.87 | | 60.00 | |
| | EC | | | | | | |

TABLE 21
Synergistic effect of Chlorantraniliprole + Flubendiamide + Diafenthiuron

| | | | | % reduction | | | |
|---|---|---|---|---|---|---|---|
| | | | | against | | | |
| | | | | control | Expected % | | Expected % |
| | | | | (Bollworm | control (By | % reduction | control (By |
| | | Dose | Dose | Complex) - | applying | against | applying |
| S. | | Formulation | a.i./ha | observed | Colby's | control | Colby's |
| No. | Treatment | (g/ml/ha) | (g) | control | formula) | (white fly) | formula) |
| 1 | Chlorantraniliprole | 1000 | 30 + | 80.93 | 75.76 | 80.01 | 77.42 |
| | 3% + Flubendiamide | | 50 + 300 | | | | |
| | 5% + Diafenthiuron | | | | | | |
| | 30% SC | | | | | | |
| 2 | Flubendiamide 20% | 250 | 50 | 45.80 | | 37.24 | |
| | WG | | | | | | |
| 3 | Chlorantraniliprole | 150 | 30 | 48.90 | | 27.58 | |
| | 18.5% SC | | | | | | |
| 4 | Diafenthiuron 50% | 600 | 300 | 12.47 | | 50.32 | |
| | WP | | | | | | |

TABLE 22
Synergistic effect of Chlorantraniliprole +
Flubendiamide + Bifenthrin

| | | | | % reduction | Expected |
|---|---|---|---|---|---|
| | | | | against | % |
| | | Dose | | control | control |
| | | Formu- | | (Bollworm | (By |
| | | lation | Dose | Complex)— | applying |
| S. | | (g/ml/ | a.i./ha | observed | Colby's |
| No. | Treatment | ha) | (g) | control | formula) |
| 1 | Chlorantraniliprole | 500 ml | 30 + | 85.85 | 79.65 |
| | 6% + Flubendiamide | | 50 + 80 | | |
| | 10% + Bifenthrin | | | | |
| | 16% SC | | | | |
| 2 | Flubendiamide | | 50 | 46.00 | |
| | 20% WG | | | | |
| 3 | Chlorantraniliprole | 150 | 30 | 49.56 | |
| | 18.5% SC | | | | |
| 4 | Bifenthrin 10% EC | 800 | 80 | 25.30 | |

TABLE 23
Synergistic effect of Chlorantraniliprole +
Flubendiamide + Lambda Cyhalothrin

| | | | | % reduction | Expected |
|---|---|---|---|---|---|
| | | | | against | % |
| | | Dose | | control | control |
| | | Formu- | | (Bollworm | (By |
| | | lation | Dose | Complex)— | applying |
| S. | | (g/ml/ | a.i./ ha | observed | Colby's |
| No. | Treatment | ha) | (g) | control | formula) |
| 1 | Chlorantraniliprole | 250 ml | 30 + | 88.12 | 81.84 |
| | 12% + Flubendiamide | | 50 + 15 | | |
| | 20% + Lambda- | | | | |
| | Cyhalothrin 6% ZC | | | | |
| 2 | Chlorantraniliprole | 500 ml | 30 + | 86.26 | 81.84 |
| | 6% + Flubendiamide | | 50 + 15 | | |
| | 10% + Lambda- | | | | |
| | Cyhalothrin 3% SC | | | | |
| 3 | Flubendiamide 20% | 100 | 50 | 46.00 | |
| | WG | | | | |
| 4 | Chlorantraniliprole | 150 | 30 | 49.56 | |
| | 18.5% SC | | | | |
| 5 | Lambda cyhalothrin | 300 | 15 | 33.31 | |
| | 5% EC | | | | |

Further, it is evident from table 20 to 23 that the observed control is more than the expected control. Hence, the composition of present invention is synergistic.

From the foregoing it will be observed that numerous modifications and variations can be effectuated without departing from the true spirit and scope of the novel concepts of the present invention. It is to be understood that no limitations with respect to the specific embodiments illustrated is intended or should be inferred. It should be understood that all such modifications and improvements have been deleted herein for the sake of conciseness and readability but are properly within the scope of the following claims.

We claim:

1. A synergistic insecticidal composition comprising:
a. Chlorantraniliprole;
b. Flubendiamide;
c. at least one compound selected from Pyriproxyfen, Diafenthiuron, Bifenthrin or Lambda-Cyhalothrin; and
d. one or more excipients

2. The composition as claimed in claim 1, comprising:
1 to 20% w/w of Chlorantraniliprole; 1 to 20% w/w of Flubendiamide; and 0.1 to 50% w/w of the at least one compound selected from Pyriproxyfen, Diafenthiuron, Bifenthrin or Lambda-Cyhalothrin.

3. The composition as claimed in claim 2, wherein the at least one compound is:
Pyriproxyfen present in the range from 5 to 50% w/w;
Diafenthiuron present in the range from 0.1 to 40% w/w;
Bifenthrin present in the range from 5 to 30% w/w; or
Lambda-Cyhalothrin present in the range from 0.1 to 40% w/w

4. The composition as claimed in claim 1, wherein the composition is selected from a group comprising:
a. 10% w/w of Chlorantraniliprole, 10% w/w of Flubendiamide; 20% w/w of Pyriproxyfen and one or more excipients;
b. 3% w/w of Chlorantraniliprole, 5% w/w of Flubendiamide; 30% w/w of Diafenthiuron and one or more excipients;
c. 6% w/w of Chlorantraniliprole, 10% w/w of Flubendiamide; 16% w/w of Bifenthrin and one or more excipients;
d. 12% w/w of Chlorantraniliprole, 20% w/w of Flubendiamide; 6% w/w of Lambda-Cyhalothrin and one or more excipients; and
e. 6% w/w of Chlorantraniliprole, 10% w/w of Flubendiamide; 3% w/w of Lambda-Cyhalothrin and one or more excipients.

5. The composition as claimed in claim 1, wherein the composition is formulated as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG), Wettable powder (WP), Water dispersible powder for slurry seed treatment (WS), Water dispersible tablet (WT), a mixed formulation of CS and SC (ZC) or A mixed formulation of CS and SE (ZE), a mixed formulation of CS and EW (ZW).

6. The composition as claimed in claim 5, wherein the composition is formulated as SC, SE and ZC.

7. The composition as claimed in claim 1, wherein the excipient is selected from the group comprising of:
dispersing agent present in an amount in the range from 2 to 10% w/w;
wetting agent present in an amount in the range from 1 to 5% w/w;
emulsifier present in an amount in the range from 2 to 7% w/w;
anti-freeze agent present in an amount in the range from 1 to 10% w/w;
defoamer present in an amount in the range from 0.01 to 0.5% w/w;
biocide present in an amount in the range from 0.01 to 0.5% w/w;
thickener present in an amount in the range from 0.01 to 0.5% w/w;
solvent present in an amount in the range from 5 to 15% w/w; and
capsule forming monomer I and II present in an amount in the range from 0.2 to 3% w/w.

8. The composition as claimed in claim 7, wherein:
the dispersing agent is selected from the group comprising amine salt of phosphate tristyryl phenol ethoxylated, acrylic copolymer, graft copolymer, salt of naphthalene sulphonate, naphthalene sulfonate formaldehyde condensate, phosphate ester, salt of polycarboxylate, alcohol block copolymer, ethoxylated polyarylphenol phosphate ester, tristyrylphenol ethoxylate phosphate ester, or a combination thereof;
the wetting agent is selected from the group comprising ethoxylated polyarylphenol phosphate ester, dioctyl sulphosuccinate, non-ionic ethoxylate, castor oil ethoxylate or a combination thereof;
the emulsifier is selected from the group comprising polyethylene oxide block copolymer, high molecular weight polymer (polyvinyl alcohol), PEG-10 PPG-5 cetyl phosphate, ethylene oxide (EO)—polyethylene oxide (PO) block copolymer, tristyryl phenol, ethoxylated nonionic emulsifier, blend of non-ionic
anionic emulsifiers or a combination thereof;
the anti-freeze agent is selected from the group comprising propylene glycol, diethylene glycol, monoethylene glycol or a combination thereof;
the defoamer is selected from the group comprising silicon emulsion, dimethyl polysiloxane emulsion, polysiloxane emulsion or a combination thereof;
the biocide is selected from the group comprising 20% aqueous dipropylene glycol solution of 1,2-benzisothiazolin-3-one, formaldehyde, isothiazolinone or a combination thereof;
the thickener is xanthan gum;
the solvent is selected from the group comprising naphtha, butan-1-ol, xylene, decanamide, N-methyl-2-pyrrolidone, dimethyl sulfoxide, solvent C9, water or a combination thereof;

9. The composition as claimed in claim 7, wherein
a) the capsule forming monomer I is selected from polyisocyanate, toluene di-isocyanate and tri-isocyanate present in an amount in the range from 0.5 to 3% w/w; and
b) the capsule forming monomer II is selected from ethylenediamine, diethylenetetramine and hexaethylenediamine present in an amount in the range from 0.2 to 2% w/w.
